(19) United States
(12) Patent Application Publication
(10) Pub. No.: US 2008/0122819 A1
(43) Pub. Date: May 29, 2008

(54) DATA DRIVING CIRCUIT AND ORGANIC LIGHT EMITTING DISPLAY COMPRISING THE SAME

(76) Inventors: Gyu Hyeong Cho, Daejeon (KR); Yong-Joon Jeon, Daejeon (KR); Young-Suk Son, Daejeon (KR); Jin Yong Jeon, Daegu (KR); Gun Ho Lee, Bucheon-si (KR)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/945,881

(22) Filed: Nov. 27, 2007

(30) Foreign Application Priority Data
Nov. 28, 2006 (KR) 10-2006-0118353

(51) Int. Cl. G09G 5/00; G09G 3/30

(52) U.S. Cl. 345/205; 345/76

(57) ABSTRACT

Provided are a data driving circuit of an organic light emitting display and an organic light emitting display comprising the same. The organic light emitting display comprises a reference pixel controller, a data driver, and a display panel. The reference pixel controller comprises a light detector for detecting an amount of light emission of a reference pixel and outputting a first control signal thereof and a reference current controller for outputting a second control signal controlling an amount of a reference current according to the first control signal. The data driver comprises a current source for outputting a current having the same amount as the reference current according to the second control signal and a digital-analog converter for outputting a data current by scaling the current having the same amount as the reference signal to be proportioned to a data signal. The display panel formed of pixels, each of which comprises an organic light emitting device that emits light in accordance with the data current.

### RELATED APPLICATION

This nonprovisional application claims priority under 35 U.S.C. §119(a) on Patent Application No. 10-2006-0118353 filed in Republic of Korea on Nov. 28, 2006, the entire contents of which are hereby incorporated by reference.

### BACKGROUND

1. Field

This document relates to a data driving circuit of an organic light emitting display and an organic light emitting display comprising the same.

2. Related Art

An organic light emitting device (OLED) is a self emissive element that emits a fluorescent material through the recombination of an electron and a hole. Compared with a liquid crystal display, an organic light emitting display using the OLED is faster in a response speed and has lower manufacturing costs and power consumption, and it has an excellent viewing angle and color reproduction.

However, the organic light emitting display has a problem of degrading the display property due to material deterioration caused by the extension of the operation time.

In order to solve such a problem, an organic light emitting display according to the related art was introduced in a patent application number WO2005/029456 has been proposed.

FIG. 1 is a diagram illustrating an optical feedback type organic light emitting display according to the related art, shown in WO2005/029456.

With reference to FIG. 1, each pixel is controlled by a select line driver and a data driver, and a signal line and a feedback line are assigned to each column of a pixel array. An Individual pixel comprising a column is selected by a select line. FIG. 2 shows a control unit, a reference cell, and a pixel circuit in detail.

With reference to FIG. 2, when a select line is activated and one pixel is selected, switches SW1 and SW2 become on so that the selected pixel is connected to a control unit and a reference cell, thereby forming a couple of feedback loops. A reference OLED sustains the same junction voltage as an OLED of a pixel circuit through a first feedback loop that comprises AMP2 and a pixel circuit, and a second feedback loop, which comprises AMP1, R2, a photo detector (PD), and a reference OLED, maintains voltages of ends of the PD the same as V_{IN}. Accordingly, the light emitted from the reference OLED sustains even brightness although the reference OLED has material deterioration, and in the same way, the OLED of the pixel circuit emits the light of the same brightness due to the first feedback loop.

However, the above method presented in the patent application number WO2005/029456 has problems as follows. That is, 1) since each column needs a reference cell, derivation of reference OLED properties of the reference cells affects the organic light emitting display in its display quality and deterioration of the display quality such as appearance of striped patterns on a screen may happen. Also, 2) the first and second feedback loops are not stable enough, so that driving voltages of the OLED of the reference cell and that of the pixel circuit has difference, thereby deteriorating the display quality of the organic light emitting display.

### SUMMARY

An aspect of this document is to improve the property of display quality of an organic light emitting display by compensating the diminution of light outputted from a pixel due to the deterioration of the OLED, thereby allowing the pixel to output the light of which brightness corresponds to an input signal.

Another aspect of this document is to prevent the deterioration of display quality of an organic light emitting display due to the property deviation of the OLED.

Yet another aspect of this document is to simplify a circuit which drives an organic light emitting display and thus reduce the manufacturing costs of the organic light emitting display.

In an aspect, an organic light emitting display comprises a reference pixel controller, a data driver, and a display panel. The reference pixel controller comprises a light detector for detecting an amount of light emission of a reference pixel and outputting a first control signal in accordance with the amount of the light emission and a reference current controller for outputting a second control signal which controls an amount of a reference current inputted to the reference pixel in accordance with the first control signal. The data driver comprises a current source for outputting a current which has the same amount as the reference current in accordance with the second control signal and a digital-analog converter for outputting a data current by scaling the current which has the same amount as the reference signal to be proportioned to a data signal. The display panel formed of pixels, each of which comprises an organic light emitting device that emits light in accordance with the data current.

The light detector may comprise a first photo conductor of which an end is electrically connected to a bias voltage source and shielded by a light cutoff material, and a second photo conductor electrically connected to the other end of the first photo conductor and having resistance which varies in accordance with the amount of light emission of the reference pixel.

The reference current controller may comprise a differential amplifying unit. The differential amplifying unit may also comprise a differential amplifier of which a reverse terminal receives the first control signal, a non-reverse terminal maintain a first constant voltage, and an output terminal outputs the second control signal, and a capacitor electrically connected between the reverse and non-reverse terminals of the differential amplifier.

The differential amplifying unit may be formed of two to ten differential amplifiers and capacitors which are connected in a multistage structure. Thus, the gain of the differential amplifying unit is made high enough.

The light detector may comprise an AC current source electrically connected with a bias voltage source, a photo conductor of which an end is electrically connected to the AC current source to have resistance which varies in accordance with the amount of light emission of the reference pixel, and an offset voltage source electrically connected to the other end of the photo conductor.

The reference current controller may comprise a peak detector electrically connected to an end of the photo conductor and for detecting the maximum of the first control signal applied from the light detector and a differential amplifying unit which comprises a differential amplifier including a reverse terminal for receiving the maximum of the first control signal, a non-reverse terminal for maintaining a first constant voltage, and an output terminal for outputting the second control signal, and a capacitor electrically connected between the reverse terminal and the output terminal of the differential amplifier.

The differential amplifying unit may be formed of two to ten differential amplifiers and capacitors which are connected in a multistage structure. Thus, the gain of the differential amplifying unit is made high enough.

The light detector may comprise a photo sensor for outputting the first control signal of a current type, the photo sensor having an end electrically connected to a bias voltage source and the other end electrically connected to the reference current controller.

The reference current controller may comprise a current-controlled oscillator for outputting a first signal of which a frequency corresponds to the first control signal applied from the photo sensor and a phase frequency detector for outputting the second control obtained by the difference between the frequency of the first signal and a reference frequency.

The light detector outputs a first control signal of a voltage type and the reference current controller may comprise a voltage-controlled oscillator for outputting a first signal having a frequency corresponding to the first control signal outputted from the light detector, and a phase frequency detector for outputting the second control signal based on the difference between the frequency of the first signal and the reference frequency.

In another aspect, a data driving circuit of an organic light emitting display comprises a light detector, a reference current controller, a current source, and a digital-analog converter. The light detector detects an amount of light emission of a reference pixel and outputting a first control signal in accordance with the amount of the light emission, and the reference current controller outputs a second control signal which controls an amount of a reference current inputted to the reference pixel in accordance with the first control signal. The current source outputs a current which has the same amount as the reference current in accordance with the second control signal; and the digital-analog converter outputs a data current by scaling the current which has the same amount as the reference signal to be proportioned to a data signal.

The light detector may comprise a first photo conductor of which an end is electrically connected to a bias voltage source and shielded by a light cutoff material and a second photo conductor electrically connected to the other end of the first photo conductor and having resistance which varies in accordance with the amount of light emission of the reference pixel.

The reference current controller may comprise a differential amplifying unit. The differential amplifying unit may also comprise a differential amplifier of which a reverse terminal receives the first control signal, a non-reverse terminal maintain a first constant voltage, and an output terminal outputs the second control signal, and a capacitor electrically connected between the reverse and non-reverse terminals of the differential amplifier.

The differential amplifying unit may be formed of two to ten differential amplifiers and capacitors which are connected in a multistage structure. Thus, the gain of the differential amplifying unit is made high enough.

The light detector may comprise an AC current source electrically connected to a bias voltage source, a photo conductor of which an end is electrically connected to the AC current source to have resistance which varies in accordance with the amount of light emission of the reference pixel, and an offset voltage source electrically connected to the other end of the photo conductor.

The reference current controller may comprise a peak detector electrically connected to an end of the photo conductor and for detecting the maximum of the first control signal applied from the light detector and a differential amplifying unit which comprises a differential amplifier including a reverse terminal for receiving the maximum of the first control signal, a non-reverse terminal for maintaining a first constant voltage, and an output terminal for outputting the second control signal, and a capacitor electrically connected between the reverse terminal and the output terminal of the differential amplifier.

The differential amplifying unit may be formed of two to ten differential amplifiers and capacitors which are connected in a multistage structure. Thus, the gain of the differential amplifying unit is made high enough.

The light detector may comprise a photo sensor for outputting the first control signal of a current type, the photo sensor having an end electrically connected to a bias voltage source and the other end electrically connected to the reference current controller.

The reference current controller may comprise a current-controlled oscillator for outputting a first signal of which a frequency corresponds to the first control signal applied from the photo sensor and a phase frequency detector for outputting the second control obtained by the difference between the frequency of the first signal and a reference frequency.

The light detector may output a first control signal of a voltage type and the reference current controller may comprise a voltage-controlled oscillator for outputting a first signal having a frequency corresponding to the first control signal outputted from the light detector and a phase frequency detector for outputting the second control signal based on the difference between the frequency of the first signal and the reference frequency.

### BRIEF DESCRIPTION OF THE DRAWINGS

The implementation of this document will be described in detail with reference to the following drawings in which like numerals refer to like elements.

FIG. 1 is a diagram illustrating an optical feedback type organic light emitting display according to the related art.

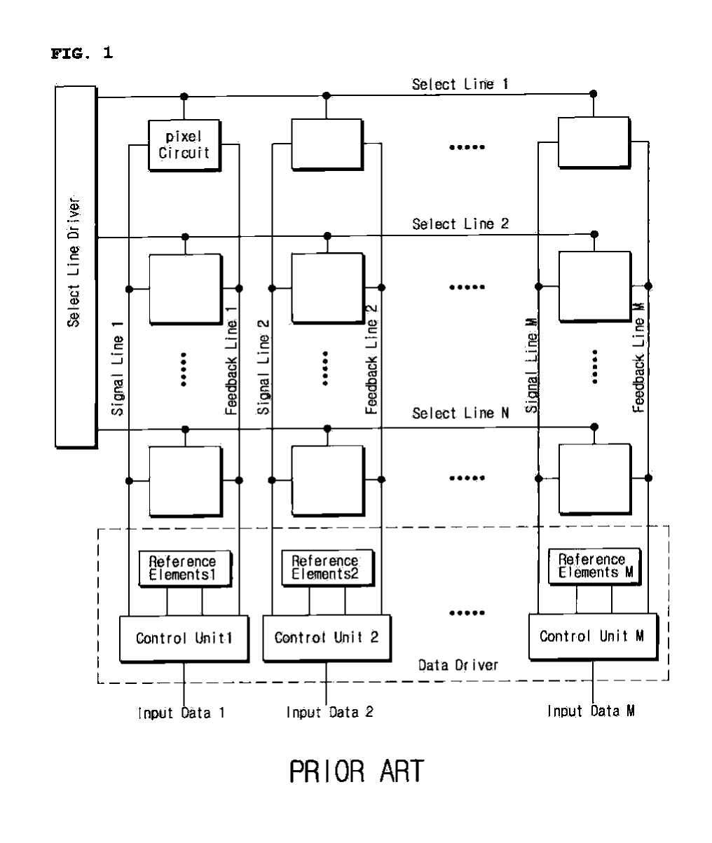

FIG. 2 is a circuit diagram of an organic light emitting display of FIG. 1.

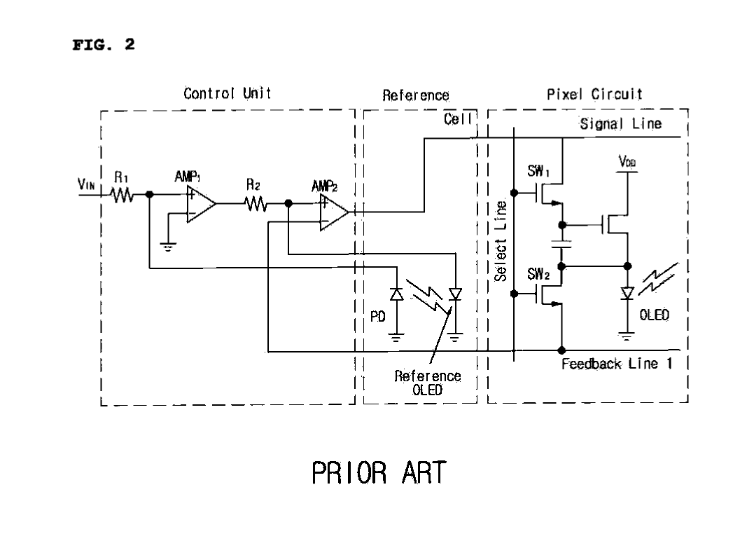

FIG. 3 is a block diagram of an organic light emitting display according to this document.

FIG. 4 is a block diagram illustrating different implementation of an organic light emitting display.

FIG. 5 is a block diagram illustrating different implementation of an organic light emitting display.

FIG. 6 is a block diagram illustrating different implementation of an organic light emitting display.

FIG. 7 is a block diagram illustrating different implementation of an organic light emitting display.

FIG. 8 is a view illustrating a pixel circuit applicable to an organic light emitting display.

FIG. 9 is a view illustrating light detectors applicable to an organic light emitting display.

### DETAILED DESCRIPTION

Hereinafter, an implementation of this document will be described in detail with reference to the attached drawings.

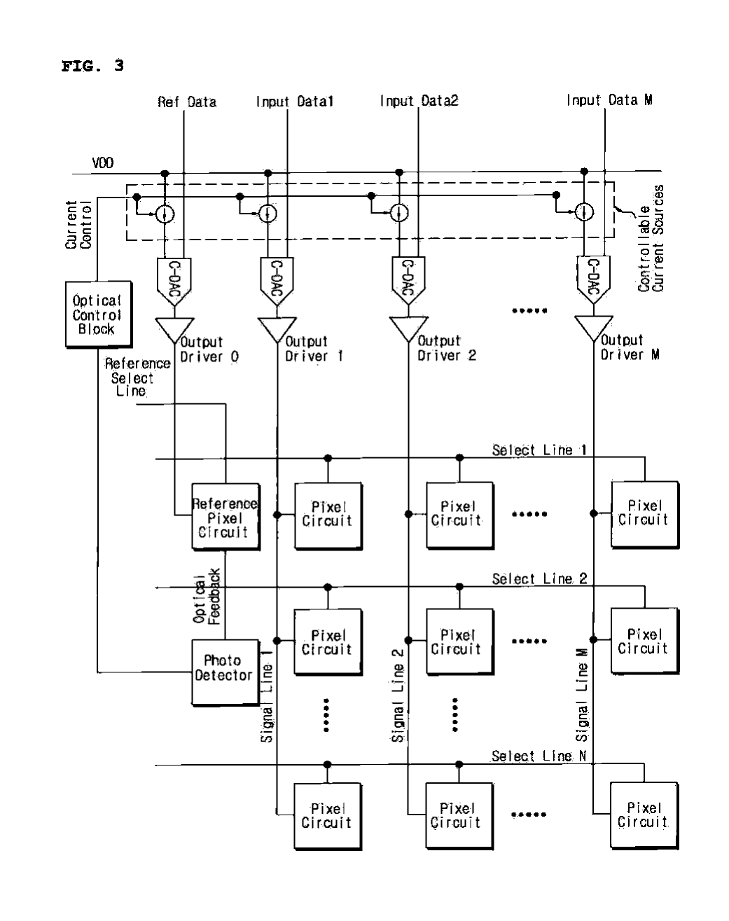

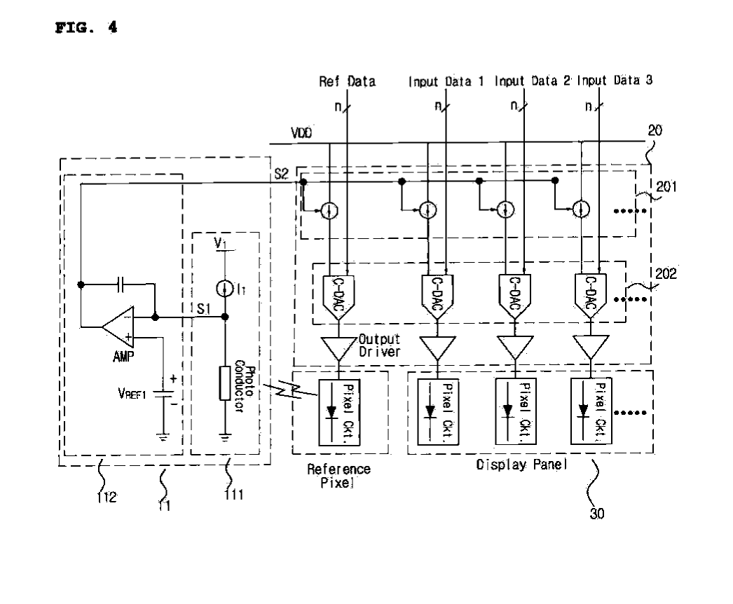

FIG. 3 is a block diagram of an organic light emitting display according to this document and FIG. 4 is a block diagram illustrating the different implementation of an organic light emitting display.

Referring to FIGS. 3 and 4, the organic light emitting display comprises a reference pixel, a reference pixel controller 11 comprising a light detector 111 and a reference current controller 112, a data driver 20 comprising a current source 201 and a digital-analog converter 202, and a display panel 30.

The reference pixel comprises a reference pixel circuit which is identical to a pixel circuit formed in a pixel of a display. A current having a mean value of currents provided to pixels of the display is supplied to the reference pixel, thereby having the reference pixel go through similar deterioration that the pixels of the display may have. If the reference pixel goes through the similar deterioration as the pixels of the display have, the amount of a current supplied to the reference pixel can be adjusted differently from the mean value of the currents provided to the pixels of the display.

The light detector 111 detects the light emission amount of a reference pixel organic light emitting device (OLED) included in the reference pixel and outputs a first control signal S1 in accordance with the light emission amount of the reference pixel organic light emitting device to the reference current controller 112. As the OLED of the reference pixel becomes deteriorated, the brightness of the light emitted to a current of the same amount decreases, so that the amount of the light detected from the light detector 111 also decreases and the light detector 111 outputs the first control signal SI which reflects such condition.

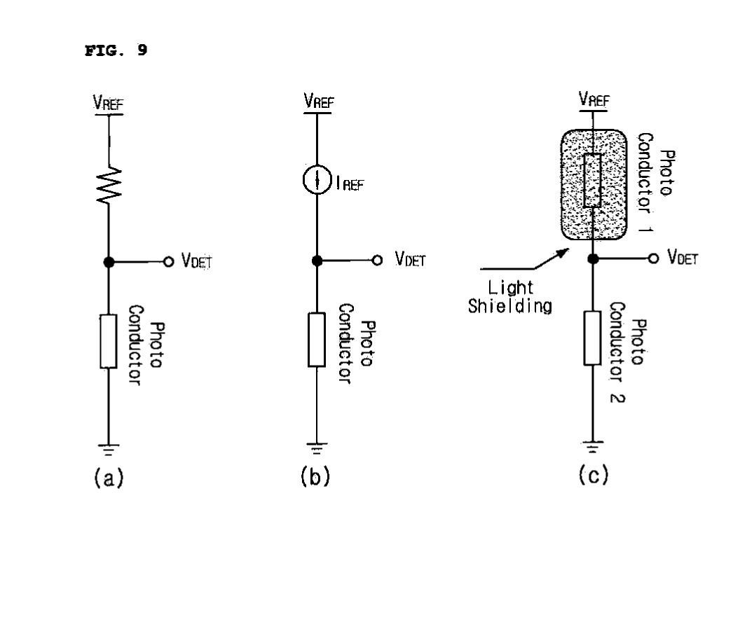

FIG. 9 shows an optical detector applicable to various implementations of an organic light emitting display. A photo conductor applied to the optical detector can be made of material which has a property of producing a photo-generated carrier when receiving visible rays such as CdS, Si, GaAs, InSb, etc., whereby the resistance of the photo conductor decreases. In FIG. 9, a detection voltage V_{DET} increases when the brightness of the light detected by the optical detector decrease and the detection voltage V_{DET} is used as a first control signal S1, The implementations (a), (b), and (c) of FIG. 9 explain a case of which a detected voltage decreases when the amount of detected light increases, however the other case having the opposite condition can also be applied. Especially, an optical detector shown in (Q) of FIG. 9 has a structure of which a photo conductor compensates a variation of property due to a stress of DC bias and voltages applied thereto. Referring to (C) of FIG. 9, the optical detector may be formed to comprise a first photo conductor 1 which is shielded by a light cutoff and has one end electrically connected to a bias voltage source V_{REF}, and a second photo conductor 2 which is connected with the other end of the first photo conductor 1 and of which resistance varies in accordance with the amount of light emission of a reference pixel. The light to be detected is emitted to the second photo conductor only, whereas the first photo conductor is light-shielded. However, the same DC current is applied to both of the first and second photo conductors 1, 2 and thus they have the same stress, whereby the relative resistance ratio maintains regularly although their electric property gradually changes. Accordingly, it is possible to considerably reduce the change of the detection voltage V_{DET} due to the property variation of the photo conductors. On the other hand, besides the use of the photo detectors, the optical detector may be embodied as p-n junction diodes, p-i-n junction diodes, metal-semiconductor diodes, avalanche photo diodes, bipolar photo transistors, field-effect photo transistors, and solar cells.

The reference current controller 112 outputs a second control signal S2 to the data driver 20, the second control signal S2 controlling the amount of reference current inputted to the reference pixel in accordance with the first control signal S1. Referring to FIG. 4, such a reference current controller may be formed to comprise a differential amplifying unit which comprises a differential amplifier AMP and a capacitor. The First control signal S1 is inputted to a reverse terminal of the differential amplifier AMP, and a non-reverse terminal thereof maintains a first constant voltage V_{REF1} and the second control signal S2 is outputted from an output terminal of the differential amplifier AMP. A capacitor is electrically connected between the reverse terminal and an output terminal of the differential amplifier AMP. The first constant voltage V_{REF1} is a detection voltage of the light detector 111, which is measured when an input current is provided into the OLED of an initial stage with no deterioration of the reference pixel. The operation of the reference current controller 112 will now be described. First, as the organic light emitting display operates, the OLED of the reference pixel deteriorates and thus the brightness of the light detected by the light detector 111 gradually decreases, whereby the detection voltage V_{DET} of the light detector 111 increases and therefore the amount of the first control signal S1 from the light detector 114 increases. Second, when the amount of the first control signal SI increases, the reference current controller 112 outputs the second control signal S2 to the current sources 201, the second control signal S2 allowing the light to emit with the brightness equivalent to the first constant voltage V_{REF1}, by the feedback of the differential amplifier AMP. Such differential amplifying unit may be formed of two to ten differential amplifiers and capacitors connected in a multistage structure. When the amplifying gain of differential amplifiers of one stage is not satisfied, enough amplifying gain can be obtained by forming the differential amplifying unit of the multistage structure.

The current source 201 outputs a current of the same amount as the reference current, in accordance with the second control signal S2, to the digital-analog converter 202 connected to the reference pixel and to the digital-analog converter 202 connected to a pixel which displays an image. Here, as the detection voltage V_{DET} increases, the amount of the first control signal S1 also increases, and the reference current controller 112 receives the first control signal S1 and then outputs the second control signal S2 through feedback, and the current source 201 receives the second control signal S2 and increases an output current corresponding to the second control signal S2.

The digital-analog converter 202 outputs a data current by scaling the current of the same amount as the reference current to be proportioned to a data signal. The digital-analog converter 202 is individually connected with the reference data line electrically connected with the reference pixel and data line which is electrically connected with the pixel displaying the image. The digital-analog converter 202 receives the identical current amount. The digital-analog converter 202 outputs an input current after scaling it to b& proportioned to the signals which are inputted to the reference data line and the data line. Accordingly, the reference pixel receives the signal in proportion to the signal inputted to the reference data line, and the pixels displaying the image receive data currents proportionate to the data signals inputted to the corresponding data lines.

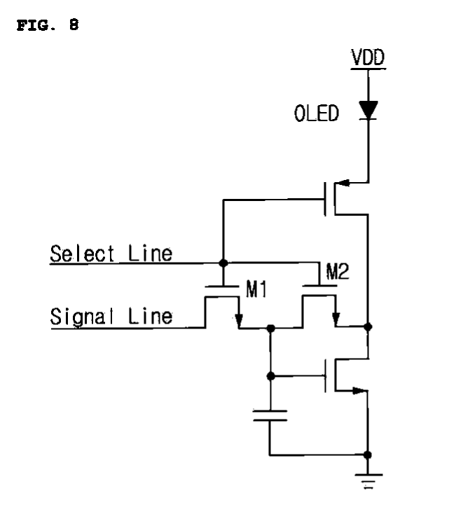

The display panel 30 is formed of pixels arrayed in a matrix type in row and column directions and an OLED of each pixel emits light responding to the amount of a data current. FIG. 8 illustrates an implementation of a pixel circuit of such a pixel. Referring to FIG. 8, when transistors M1 and M2 are turned on by a select signal from a select line, an OLED emits light by a current, which flows from a power voltage source VDD to a ground corresponding to a data current applied to a signal line.

As described above, when the amount of light emitted by the OLED of the reference pixel decreases due to deterioration, the amount of the reference current supplied to the digital-analog converter 202 increases, thereby increasing the amount of the current applied to each pixel. To describe this in more detail, a feedback loop is formed by the reference pixel, the light detector 111, the reference current controller 112, the current source 201, and the digital-analog converter 202. Such a feedback loop allows the OLED of the reference pixel to emit light of uniform brightness regardless of the degree of the OLED deterioration of the reference pixel by controlling the amount of an output current of the current source 201 so that the light having the same brightness as the light emitted by the OLED of the reference pixel at an initial operation stage of the organic light emitting display, that is, when the OLED of the reference pixel is not yet affected by its property deterioration. In the result, the decrease in brightness due to deterioration of the OLED of the pixel displaying the image can be compensated by allowing the OLED of the pixel displaying the image and the OLED of the reference pixel to go through similar deterioration and compensating the decrease of brightness due to the OLED of the reference pixel.

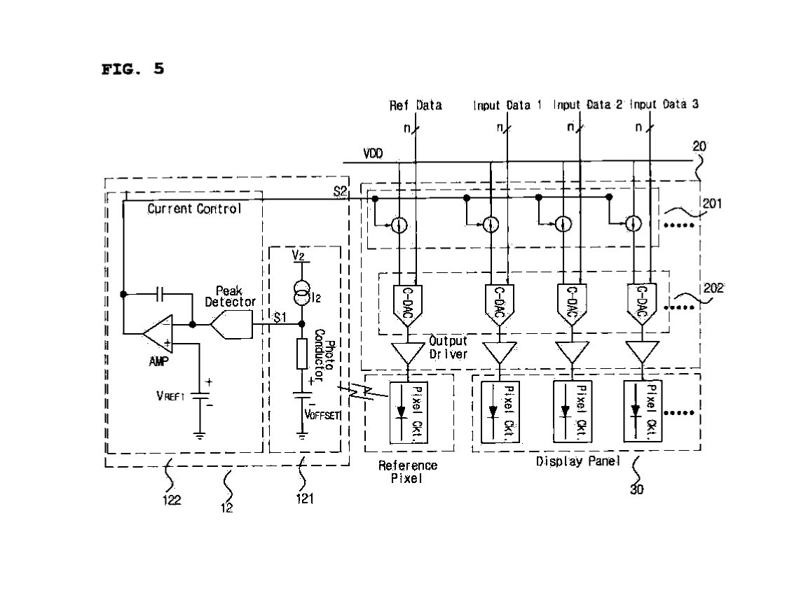

FIG. 5 is a diagram illustrating a different implementation of an organic light emitting display.

The organic light emitting display illustrated in FIG. 5 is different from the organic light emitting display shown in FIG. 4 in a light detector 121 and a reference current controller 122.

Here, the description will be made concentrating on the difference of the above two units.

Referring to FIG. 5, the light detector 121 comprises a photo conductor and an offset voltage source V_{OFFSET}. The photo conductor comprises an end electrically connected to an AC current source I₂ which is electrically connected with a bias voltage source V₂. The offset voltage source V_{OFFSET} is electrically connected to the other end of the photo conductor, wherein resistance of the photo conductor varies in accordance with the amount of light emitted by a reference pixel. The reference current controller 122 comprises a peak detector, a differential amplifying unit, and a capacitor. The peak detector is electrically connected to an end of the photo conductor and detects the maximum of a first control signal S1 applied from the light detector 121. The differential amplifying unit comprises a differential amplifier AMP that comprises a reverse terminal for receiving the maximum of the first control signal SI, a non-reverse terminal for maintaining a first constant voltage V_{REF1}, and an output terminal for outputting the second control signal S2. The capacitor is electrically connected between the reverse terminal of the differential amplifier AMP and the output terminal thereof.

The organic light emitting display prevent property change due to the stress occurred by which DC bias is applied to the photo conductor of the light detector 121. The light emitted by the reference pixel maintains the uniform amount of brightness by applying an AC current to the light detector 121, then detecting the peak of an AC voltage applied to the photo conductor using the peak detector, and feeding back the peak value, thereby compensating the deterioration of the OLED of the reference pixel. Here, an output waveform of the AC current may have a random AC waveform such as a sinusoid wave, a rectangular wave, a saw-tooth wave, etc. of which the mean value maintains 0.

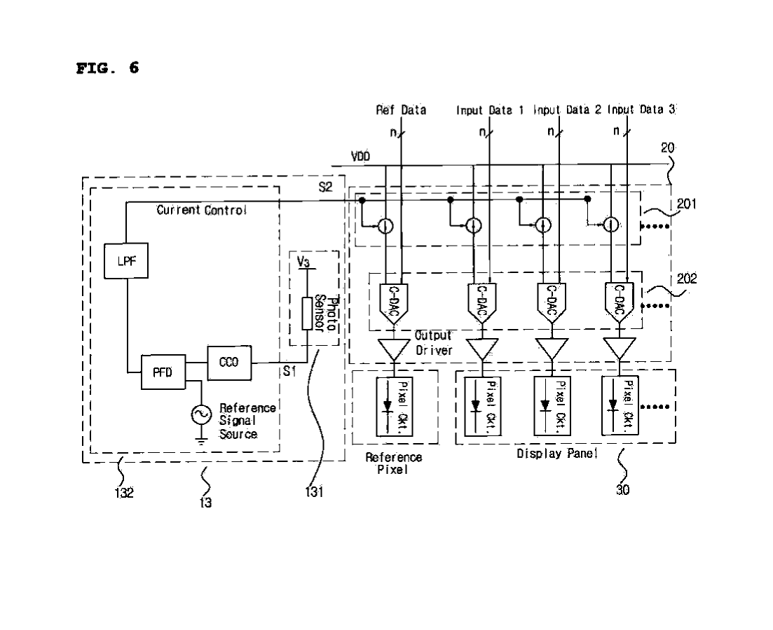

FIG. 6 is a diagram illustrating a different implementation of an organic light emitting display.

The organic light emitting display illustrated in FIG. 6 is different from the organic light emitting display shown in FIG. 4 in a light detector 131 and a reference current controller 132.

Here, the description will be made concentrating on the difference of the above two units.

Referring to FIG. 6, the light detector 131 comprises a photo sensor. The photo sensor comprises an end electrically connected with a bias voltage V₃ and the other end electrically connected with the reference current controller 132. The photo sensor outputs a first control signal S1 of a current type. The reference current controller 132 comprises a current-controlled oscillator CCO and a phase frequency detector PFD. The current-controlled oscillator CCO outputs a first signal having a frequency corresponding to the first control signal S1 applied from the photo sensor, and the phase frequency detector PFD outputs a second control signal S2 based on the difference between the frequency of the first signal and a reference frequency. The organic light emitting display compensates the deterioration of an OLED included in a reference pixel using feedback of a phase locked loop which comprises the CCO. And, it detects by the photo sensor the brightness of the light emitted by the reference pixel at an initial stage, that is, before the deterioration of the OLED of the reference pixel starts, converts the detected value to a corresponding current capacity, and determines an output frequency from the CCO which is generated in accordance with the current capacity as the reference frequency of a reference signal source. When the brightness of the light emitted gradually decreases corresponding to an input current as the OLED of the reference pixel deteriorates, the current capacity provided to the CCO through the photo sensor is also decreased. Accordingly, the frequency of an output signal of the CCO lowers, that makes a difference between the frequency thereof and the reference frequency of the reference signal source. The PFD detects the difference between the two frequencies, generates an output voltage in proportion to the difference, and feeds back the output voltage, thereby uniformly maintaining the brightness of the reference pixel. A photo conductor and a thin film transistor (TFT), etc., that are able to detect visible rays such as CdS, Si, GaAs, and InSb, etc., may be used as the photo sensor.

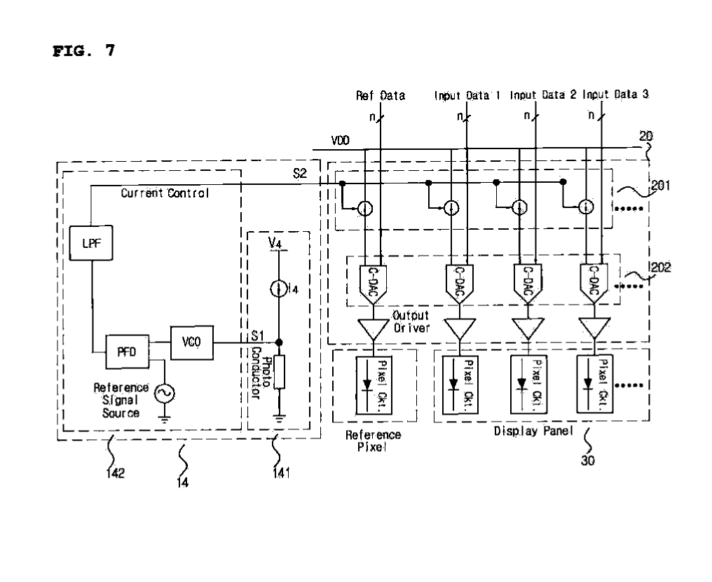

FIG. 7 is a diagram illustrating different implementation of an organic light emitting display.

The organic light emitting display illustrated in FIG. 7 is different from the organic light emitting display shown in FIG. 4 in the part of a reference current controller 142.

Now, the description will be made concentrating on the difference between the two exemplary embodiments of the present invention.

Referring to FIG. 7, a light detector 141 outputs a first control signal S1 of a voltage type. The reference current controller 142 comprises a voltage-controlled oscillator VCO and a phase frequency detector PFD. The voltage-controlled oscillator VCO outputs a first signal having a frequency corresponding to the first control signal S1 outputted from the light detector 141. The phase frequency detector PFD outputs a second control signal S2 based on the difference between the frequency of the first signal and the reference frequency.

The organic light emitting display has been implemented by applying the VCO to the reference current controller 142. The organic light emitting display detects by a photo conductor the brightness of the light emitted by the reference pixel at an initial stage, that is, before the deterioration of the OLED of the reference pixel starts, converts the detected value to a corresponding voltage, and determines an output frequency from the VCO which is generated in accordance with the voltage as the reference frequency of a reference signal source. When the brightness of the light emitted corresponding to an input voltage gradually decreases as the OLED of the reference pixel deteriorates, the voltage outputted from the light detector 141 to the VCO is also increased. Accordingly, the frequency of an output signal of the VCO increases, that makes a difference between the frequency thereof and the reference frequency of the reference signal source. The PFD detects the difference between the two frequencies, generates an output voltage in proportion to the difference, and feeds back the output voltage, thereby uniformly maintaining the brightness of the reference pixel.

A data driving circuit of an organic light emitting display comprises a light detector, a reference current controller, a current source unit, and a digital-analog converter. The light detector detects the light emitting amount of a reference pixel and outputs a first control signal in accordance with the light emitting amount of the reference pixel. The reference current controller outputs a second control signal controlling the amount of a reference current inputted to the reference pixel in accordance with the first control signal. The current source unit outputs a current of the same amount as the reference current in accordance with the second control signal, and the digital-analog converter outputs a data current by scaling the current of the same amount as the reference current to be proportioned to the data signal. The reference current controller comprises a differential amplifying unit and a capacitor. The differential amplifying unit comprises a differential amplifier that has a reverse terminal for receiving the first control signal, a non-reverse terminal for maintaining a first constant voltage, and an output terminal for outputting the second control signal. The capacitor is electrically connected between the reverse terminal and the output terminal of the differential amplifier.

The description of the data driving circuit of the organic light emitting display will be substituted by the description of the organic light emitting display shown in FIG. 4.

Another implementation of a data driving circuit of an organic light emitting display comprises a light detector, a reference current controller, and a current source unit, and a digital-analog converter. The light detector detects the light emitting amount of a reference pixel and outputs a first control signal in accordance with the light emitting amount of the reference pixel. The reference current controller outputs a second control signal controlling the amount of a reference current inputted to the reference pixel in accordance with the first control signal. The current source unit outputs a current of the same amount as the reference current in accordance with the second control signal, and the digital-analog converter outputs a data current by scaling the current of the same amount as the reference current to be proportioned to the data signal.

The light detector comprises a photo conductor and an offset voltage source. The photo conductor comprises an end electrically connected to an AC current source which is electrically connected with a bias voltage, wherein the resistance of the photo conductor varies in accordance with the light emitting amount of the reference pixel. The offset voltage source is electrically connected to the other end of the photo conductor. The reference current controller comprises a peak detector and a differential amplifying unit. The peak detector is electrically connected to an end of the photo conductor and detects the maximum of the first control signal applied from the light detector. The differential amplifying unit comprises a differential amplifier and a capacitor. The differential amplifier comprises a reverse terminal for receiving the first control signal, a non-reverse terminal for maintaining a first constant voltage, and an output terminal for outputting the second control signal. The capacitor is electrically connected between the reverse terminal and the output terminal of the differential amplifier.

The description of another implementation of the data driving circuit of the organic light emitting display will be substituted by the organic light emitting display shown in FIG. 5.

Still another implementation of a data driving circuit of an organic light emitting display comprises a light detector, a reference current controller, a current source unit, and a digital-analog converter. The light detector detects the light emitting amount of a reference pixel and outputs a first control signal in accordance with the light emitting amount of the reference pixel. The reference current controller outputs a second control signal controlling the amount of a reference current inputted to the reference pixel in accordance with the first control signal. The current source unit outputs a current of the same amount as the reference current in accordance with the second control signal. The digital-analog converter outputs a data current by scaling the current of the same amount as the reference current to be proportioned to the data signal. The light detector comprises a photo sensor that comprises an end electrically connected with a bias voltage and the other end electrically connected with the reference current controller. The photo sensor outputs the first control signal of a current type. The reference current controller comprises a current-controlled oscillator and a phase frequency detector. The current-controlled oscillator outputs a first signal having a frequency corresponding to the first control signal applied from the photo sensor. The phase frequency detector outputs the second control obtained by the difference between the frequency of the first signal and the reference frequency.

The description of still another implementation of the data driving circuit of the organic light emitting display will be substituted by the description of the organic light emitting display shown in FIG. 6.

Yet another implementation of a data driving circuit of an organic light emitting display comprises a light detector, a reference current controller, a current source unit, and a digital-analog converter. The light detector detects the light emitting amount of a reference pixel and outputs a first control signal in accordance with the light emitting amount of the reference pixel. The reference current controller outputs a second control signal controlling the amount of a reference current inputted to the reference pixel in accordance with the first control signal. The current source unit outputs a current of the same amount as the reference current in accordance with the second control signal, and the digital-analog converter outputs a data current by scaling the current of the same amount as the reference current to be proportioned to the data signal. The light detector outputs a first control signal of a voltage type, and the reference current controller comprises a voltage-controlled oscillator which outputs a first signal having a frequency corresponding to the first control signal outputted from the light detector and a phase frequency detector which outputs the second control signal based on the difference between the frequency of the first signal and the reference frequency.

The description of yet another implementation of the data driving circuit of the organic light emitting display will be substituted by the description of the organic light emitting display shown in FIG. 7.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

As described above, the organic light emitting display according to this document has the effect of improving the property of display quality of the organic light emitting display by compensating the diminution of the light outputted from the pixel due to the deterioration of the OLED, thereby allowing the pixel to output the light of which brightness corresponds to the input signal.

Also, the organic light emitting display according to this document has the effect of preventing the deterioration of display quality of the organic light emitting display due to the property deviation of the OLED.

In addition, the organic light emitting display according to this document has the effect of simplifying the circuit which drives the organic light emitting display and thus reducing the manufacturing costs of the organic light emitting display.

What is claimed is:

1. An organic light emitting display comprising:
a reference pixel controller comprising a light detector for detecting an amount of light emission of a reference pixel and outputting a first control signal in accordance with the amount of the light emission and a reference current controller for outputting a second control signal which controls an amount of a reference current inputted to the reference pixel in accordance with the first control signal;
a data driver comprising a current source for outputting a current which has the same amount as the reference current in accordance with the second control signal and a digital-analog converter for outputting a data current by scaling the current which has the same amount as the reference signal to be proportioned to a data signal; and
a display panel formed of pixels, each of which comprises an organic light emitting device that emits light in accordance with the data current.

2. The organic light emitting display of claim 1, wherein the light detector comprises:
a first photo conductor of which an end is electrically connected to a bias voltage source and shielded by a light cutoff material; and
a second photo conductor electrically connected to the other end of the first photo conductor and having resistance which varies in accordance with the amount of light emission of the reference pixel.

3. The organic light emitting display of claim 1, wherein the reference current controller comprises a differential amplifying unit,
wherein the differential amplifying unit comprises
a differential amplifier of which a reverse terminal receives the first control signal, a non-reverse terminal maintain a first constant voltage, and an output terminal outputs the second control signal; and
a capacitor electrically connected between the reverse and non-reverse terminals of the differential amplifier.

4. The organic light emitting display of claim 3, wherein the differential amplifying unit is formed of two to ten differential amplifiers and capacitors which are connected in a multistage structure.

5. The organic light emitting display of claim 1, wherein the light detector comprises
an AC current source electrically connected with a bias voltage source;
a photo conductor of which an end is electrically connected to the AC current source to have resistance which varies in accordance with the amount of light emission of the reference pixel; and
an offset voltage source electrically connected to the other end of the photo conductor.

6. The organic light % emitting display of claim 5, wherein the reference current controller comprises
a peak detector electrically connected to an end of the photo conductor and for detecting the maximum of the first control signal applied from the light detector; and
a differential amplifying unit which comprises a differential amplifier including a reverse terminal for receiving the maximum of the first control signal, a non-reverse terminal for maintaining a first constant voltage, and an output terminal for outputting the second control signal, and a capacitor electrically connected between the reverse terminal and the output terminal of the differential amplifier.

7. The organic light emitting display of claim 6, wherein the differential amplifying unit is formed of two to ten differential amplifiers and capacitors which are connected in a multistage structure.

8. The organic light emitting display of claim 1, wherein the light detector comprises
a photo sensor for outputting the first control signal of a current type, the photo sensor having an end electrically connected to a bias voltage source and the other end electrically connected to the reference current controller.

9. The organic light emitting display of claim 8, wherein the reference current controller comprises
a current-controlled oscillator for outputting a first signal of which a frequency corresponds to the first control signal applied from the photo sensor; and
a phase frequency detector for outputting the second control signal obtained by the difference between the frequency of the first signal and a reference frequency.

10. The organic light emitting display of claim 1, wherein the light detector outputs a first control signal of a voltage type and the reference current controller comprises:
a voltage-controlled oscillator for outputting a first signal having a frequency corresponding to the first control signal outputted from the light detector; and
a phase frequency detector for outputting the second control signal based on the difference between the frequency of the first signal and the reference frequency.

11. A data driving circuit of an organic light emitting display comprising:
a light detector for detecting an amount of light emission of a reference pixel and outputting a first control signal in accordance with the amount of the light emission;
a reference current controller for outputting a second control signal which controls an amount of a reference current inputted to the reference pixel in accordance with the first control signal;
a current source for outputting a current which has the same amount as the reference current in accordance with the second control signal; and
a digital-analog converter for outputting a data current by scaling the current which has the same amount as the reference signal to be proportioned to a data signal.

12. The data driving circuit of the organic light emitting display of claim 11, wherein the light detector comprises:
a first photo conductor of which an end is electrically connected to a bias voltage source and shielded by a light cutoff material; and
a second photo conductor electrically connected to the other end of the first photo conductor and having resistance which varies in accordance with the amount of light emission of the reference pixel.

13. The data driving circuit of the organic light emitting display of claim 11, wherein the reference current controller comprises a differential amplifying unit,
wherein the differential amplifying unit comprises
a differential amplifier of which a reverse terminal receives the first control signal, a non-reverse terminal maintain a first constant voltage, and an output terminal outputs the second control signal; and
a capacitor electrically connected between the reverse and non-reverse terminals of the differential amplifier.

14. The data driving circuit of the organic light emitting display of claim 13, wherein the differential amplifying unit is formed of two to ten differential amplifiers and capacitors which are connected in a multistage structure.

15. The data driving circuit of the organic light emitting display of claim 11, wherein the light detector comprises:
an AC current source electrically connected to a bias voltage source;
a photo conductor of which an end is electrically connected to the AC current source to have resistance which varies in accordance with the amount of light emission of the reference pixel; and
an offset voltage source electrically connected to the other end of the photo conductor.

16. The data driving circuit of the organic light emitting display of claim 15, wherein the reference current controller comprises:
a peak detector electrically connected to an end of the photo conductor and for detecting the maximum of the first control signal applied from the light detector; and
a differential amplifying unit which comprises a differential amplifier including a reverse terminal for receiving the maximum of the first control signal, a non-reverse terminal for maintaining a first constant voltage, and an output terminal for outputting the second control signal, and a capacitor electrically connected between the reverse terminal and the output terminal of the differential amplifier.

17. The data driving circuit of the organic light emitting display of claim 16, wherein the differential amplifying unit is formed of two to ten differential amplifiers and capacitors which are connected in a multistage structure.

18. The data driving circuit of the organic light emitting display of claim 11, wherein the light detector comprises:
a photo sensor for outputting the first control signal of a current type, the photo sensor having an end electrically connected to a bias voltage source and the other end electrically connected to the reference current controller.

19. The data driving circuit of the organic light emitting display of claim 18, wherein the reference current controller comprises:
a current-controlled oscillator for outputting a first signal of which a frequency corresponds to the first control signal applied from the photo sensor; and
a phase frequency detector for outputting the second control obtained by the difference between the frequency of the first signal and a reference frequency.

20. The data driving circuit of the organic light emitting display of claim 11, wherein the light detector outputs a first control signal of a voltage type and the reference current controller comprises:
a voltage-controlled oscillator for outputting a first signal having a frequency corresponding to the first control signal outputted from the light detector; and
a phase frequency detector for outputting the second control signal based on the difference between the frequency of the first signal and the reference frequency.
